(19) United States
(12) Patent Application Publication
(10) Pub. No.: US 2012/0133639 A1
(43) Pub. Date: May 31, 2012

(54) STRIP PANORAMA

(75) Inventors: Johannes Kopf, Bellevue, WA (US); Michael Cohen, Seattle, WA (US)

(73) Assignee: Microsoft Corporation, Redmond, WA (US)

(21) Appl. No.: 12/957,124

(22) Filed: Nov. 30, 2010

(51) Int. Cl. G06T 15/00

(52) U.S. Cl. 345/419

(57) ABSTRACT

A technology is described for generating a strip panorama. The method can include selecting panoramas grouped together for a road to combine into the strip panorama. Side view images can be extracted from the plurality of panoramas. Another operation is computing depth maps for side view images using stereo matching. Depth histograms can be generated for depth map columns of the depth maps. The depth histograms can have column-depth alignment scores computed by multiplying corresponding depth values from at least two related depth histogram maps. A further operation can be aligning related side view images using the column-depth alignment scores. The aligned side view images can be stitched while maximizing a stitching score.

### BACKGROUND

For many years, the ability to virtually visit remote locations has been a goal in the field of computer graphics. Immersive experiences based on 360 degree panoramas have long been a component of virtual reality (VR) photography, especially due to the availability of digital cameras and reliable automated stitching software. Some street mapping systems such as Microsoft Bing Maps' Streetside and Google's Street View can allow users to virtually visit geographic points by sequentially navigating between immersive 360 degree panoramas sometimes referred to as panoramas or image bubbles.

While panning and zooming inside a panorama provides a photorealistic impression from a particular viewpoint, these functions do not provide a good visual sense of a larger aggregate location such as a whole city block or a long city street. Navigating through these panorama photo collections can be laborious and similar to hunting for a given location on foot. Specifically, a user may have to virtually walk along the street, (e.g., jumping from panorama to panorama in a street view) and pan around until the user finds the location of interest. Since automatically geo-located addresses or GPS (Global Positioning System) readings are often off by 50 meters or more, especially in urban settings, visually searching for a location is often used. In addition, severe foreshortening of a street side view from such a distance can make recognition of many map features difficult within a panorama view.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. While certain disadvantages of prior technologies are noted above, the claimed subject matter is not to be limited to implementations that solve any or all of the noted disadvantages of the prior technologies.

Various embodiments of a technology are described for generating a strip panorama. The method can include selecting panoramas grouped together for a road to combine into the strip panorama. Side view images can be extracted from the plurality of panoramas. Another operation is computing depth maps for side view images using stereo matching. Depth histograms can be generated for depth map columns of the depth maps. The depth histograms can have column-depth alignment scores computed by multiplying corresponding depth values from at least two related depth histogram maps. A further operation can be aligning related side view images using the column-depth alignment scores. The aligned side view images can be stitched while maximizing a stitching score.

An example system for generating a multi-perspective strip panorama can also be provided. The system can include an extraction module to extract side view images from panoramas grouped together for a road. A depth map module can compute depth maps for side view images using stereo matching and generate column-depth alignment scores for pairs of depth maps for the side view images. An alignment module can align related side view images using the column-depth alignment scores. In addition, a stitching module can be configured to stitch aligned side view images while maximizing a stitching score.

### BRIEF DESCRIPTION OF THE DRAWINGS

FIG. 1 is a flowchart illustrating an example of a method for generating multi-perspective strip images.

FIG. 2 is an example of images forming a panorama or image cube.

FIG. 3 is an example of a multi-perspective strip view.

FIG. 4 is a block diagram illustrating an example system for generating multi-perspective strip images.

FIG. 5A illustrates an example view of road segments.

FIG. 5B illustrates an example view of a zoomed-in image of FIG. 5A with each cross icon representing a panorama taken on a road.

FIG. 6A illustrates an example of a side view image that may be used to generate a depth map.

FIG. 6B illustrates an example of a corresponding depth map for FIG. 6A.

FIG. 7A illustrates an example of a depth map.

FIG. 7B illustrates an example of a depth histogram that can be created using the depth map of FIG. 7A.

FIG. 8A is an example depth histogram.

FIG. 8B is an example depth histogram that would be near the depth histogram in FIG. 8A.

FIG. 8C is an example depth histogram with noise removed that is generated by multiplying the depth histogram of FIG. 8A with the depth histogram of FIG. 8B.

FIG. 9A illustrates an example depth histogram.

FIG. 9B illustrates an example of a bluffed depth histogram using the horizontal blur kernel applied to FIG. 9A.

FIG. 10 is a block diagram illustrating an example of a stitching process using two depth histograms.

FIG. 11A illustrates an example of stitching of side view images where various levels of gray scale represent the amount of a side view image that is stitched into the strip panorama.

FIG. 11B illustrates the example stitched strip panorama as represented by FIG. 11A.

FIG. 12A illustrates example Graph cuts in the strip panorama as identified by different levels of gray scale for the strip panorama.

FIG. 12B illustrates an example of an output image based on the Graph cuts of FIG. 12A where the cars and the right tower type of building are left intact in the strip panorama.

FIG. 13 illustrates an example strip panorama after Laplacian blending.

FIG. 14 illustrates an example of another method for generating multi-perspective strip panoramas.

### DETAILED DESCRIPTION

Reference will now be made to the example embodiments illustrated in the drawings, and specific language will be used herein to describe the same. It will nevertheless be understood that no limitation of the scope of the technology is thereby intended. Alterations and further modifications of the features illustrated herein, and additional applications of the technology as illustrated herein, which would occur to one skilled in the relevant art and having possession of this disclosure, are to be considered within the scope of the description.

As discussed, systems such as Microsoft Bing Maps' Streetside and Google's Street View can enable users to virtually visit geographic areas and cities by navigating from one immersive 360 degree panorama to another. Since each panorama is discrete, moving from panorama to panorama in such systems may not provide a good visual sense of a larger aggregate area, such as a whole city block.

In order to overcome the limitations of moving from panorama to panorama in a mapping tool, multi-perspective strip panoramas can be used for viewing streets or other geographic areas. These strip panoramas can provide a useful visual summary of the landmarks and other elements along a street. Strip panoramas can be created using the images captured to form the 360 degree panoramas. However, combining images together from the panoramas in such a way that the images appear as though the images are one image taken at the same point in time can be challenging. Further, determining how the images should be combined together to make the most realistic final image can also be problematic.

This technology can obtain images and metadata describing the location and orientation of captured panoramas that may be converted to strip panoramas. These image panoramas can be associated with a database of roads or a road network in an area corresponding to the captured image panoramas. The road network can be a network of linked road segments for a map.

An example of the technology can be described using some main operations. An initial operation can be planning. The planning operations can determine which road segments to group together and which image panoramas to associate together for those road segments. The side view images can then be extracted from the panoramas by rendering wide angle side-facing views. Then strip panoramas or block views can be created by stitching together the side view images.

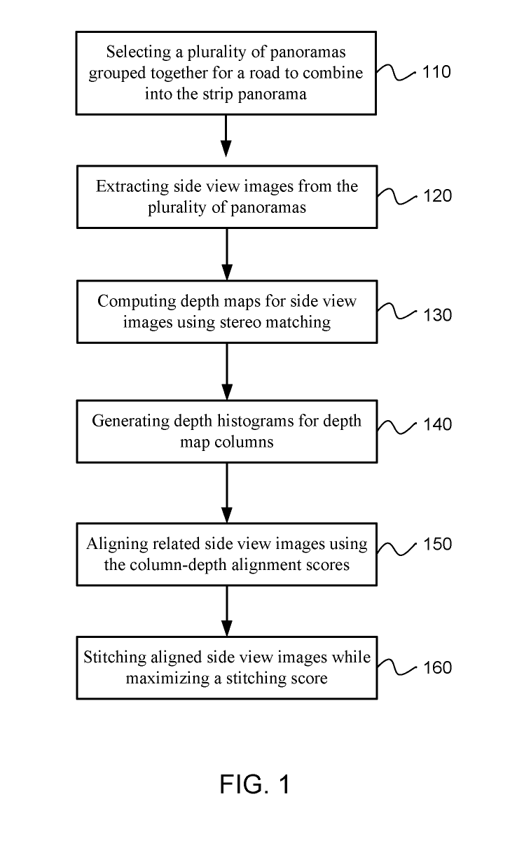

Another high-level example of a method for generating multi-perspective strip panoramas can be provided. FIG. 1 illustrates that the method can include the operation of selecting a plurality of panoramas grouped together for a road to combine into the strip panorama, as in block 110. Each road can have many panoramas associated with the road.

A plurality of side view images can be extracted from the panoramas, as in block 120. These side view images can be created by extracting the side views from the image panorama so that a number of successive views of objects on the sides of the street are captured. In other words, a plurality of panoramas can be grouped together based on grouped road segments. The panoramas can be grouped together by optimizing a score function based on panoramas that are: close to a road vector, oriented along the road vector, subsequent panoramas from the same vehicle photographic run, or panoramas that minimize jumps between panoramas taken using different vehicles. In an example, these side view images can be adjacent images that overlap in the subject matter captured for a road.

Depth maps can then be computed for side view images using stereo matching, as in block 130. The depth maps can include a depth for each pixel in the side view image by using stereo images for extracting depth. These stereo images may be adjacent images.

Depth histograms can be generated for a depth map and the depth map columns contained in the depth map. Such depth histograms can be stored in a grid format and represented as an image with pixels. The depth histograms can have columns corresponding to columns in the depth images and rows that are bins for different depth ranges. The depth histograms may have column-depth alignment scores computed by multiplying corresponding depth values from at least two of the related depth histogram maps, as in block 140.

A horizontal blur convolution kernel may be applied to the column-depth alignment scores of the depth histograms to increase a relative magnitude of horizontal structures in the depth histograms and enable a stitching operation to better identify a depth of manmade structures in the side view images. Examples of manmade objects that can be more easily identified as a depth plane for matching between two side view images can include: buildings, signs, mail boxes and other relatively planar objects.

Related side view images can be aligned using the depth histograms, as in block 150. Peaks can then be identified in the column-depth alignment scores of the depth histogram to determine a column to use for aligning a side view image with another side view image. The identified peaks can be used as a starting point for aligning the side view images. For example, a depth of a building facade can be used as a chosen depth for aligning and stitching side view images.

Aligned side view images can be stitched together while maximizing a stitching score, as in block 160. For example, a stitching score can be maximized by optimizing for stitching features or attributes such as: alignment quality, favoring for stitching on front-parallel building facades, favoring selecting center regions from the images, and favoring wide slabs from images near intersections.

Once the side view images have been stitched together, vertical seams between the images are created. The vertical seams can be refined by using Graph cuts, blending and trimming the strip panorama. The photographic exposure settings between the side view images can also be balanced between the side view images using gain compensation. Then trimming lines can be computed for the top and bottom edges of the strip panorama.

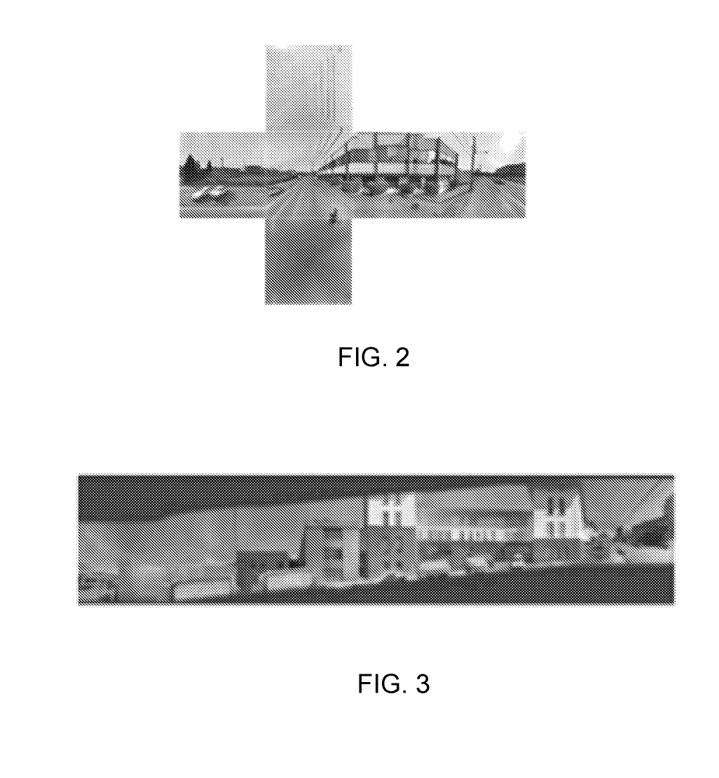

FIG. 2 illustrates that the input to the technology can be a number of street level single-viewpoint panoramic images that are captured by vehicles driving systematically on a number of streets in a geographical area (e.g., a city road, highway, or another road). A more casual term for the street level panoramas can be “bubbles”. These panoramas can be stored in memory as cube maps.

The output of the technology can be a set of multi-perspective panoramas as illustrated in FIG. 3, where one strip panorama is provided for a side of a street. The output of the panoramas can also be called “block views” because an individual can view a large portion of a city block a one time.

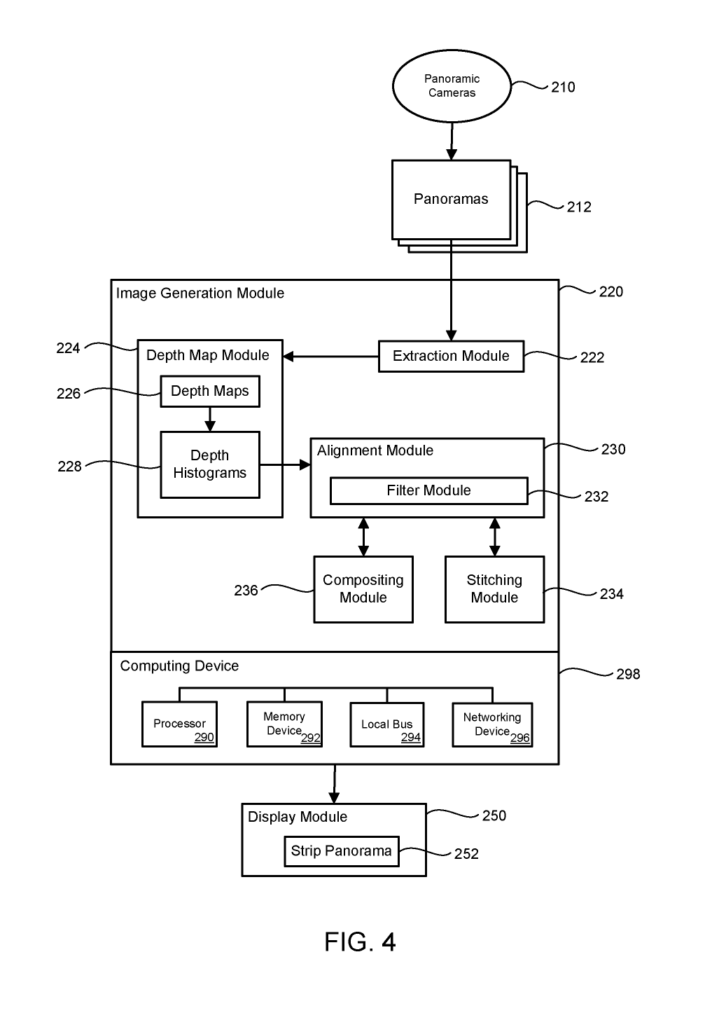

FIG. 4 illustrates a system for generating multi-perspective strip panoramas using an image generation module 220. The system can include an extraction module 222 in the image generation module to extract side view images from panoramas 212 grouped together as a street or block view. These side view images can come from panoramic cameras 210 and the side view images can be stored in a computer memory device such as a volatile memory device, a non-volatile memory device, or a mass storage device. Panoramic cameras can include one or more wide angle cameras used to capture a 360 degree panorama.

A depth map module 224 can be used to compute depth maps 226 for side view images using stereo matching, and the depth map module can also generate depth histograms 228 for pairs of depth maps for the side view images. The depth histograms can include columns corresponding to columns in the depth maps. Rows in the depth histograms can be depth bins that record the number of pixels in a column of a depth map at a defined depth. These values in the depth histograms can be defined as column-depth alignment scores. Gradient values or color values in the depth histogram can represent a number of pixels categorized into a depth bin.

An alignment module 230 can align related side view images using the column-depth alignment scores in the depth histograms 228. Peaks in the column-depth alignment scores of the depth histogram can be identified by the alignment module to determine an image column to use for aligning a side view image near another side view image. The side view images being aligned may also be adjacent images.

A filter module 232 can apply a horizontal blur convolution kernel to the column-depth alignment scores of the depth histogram to increase a relative magnitude of horizontal structures in the depth histogram. Applying a blurring filter can enable a stitching operation to more accurately identify a depth of manmade structures or other structures suitable for alignment purposes.

A stitching module 234 can stitch the aligned side view images while solving a local or global stitching score. The global stitching score can be a sum of the local column-depth alignment scores for the selected columns. Dynamic Programming (DP) can be applied to decide which columns to use based on solving for a global score. DP can be applied to decide the specific column to use for each alignment such that the sum of the alignment columns is a good fit or maximized. A Graph cut operation can be included with a compositing module 236 to refine vertical seams created by stitching using Graph cuts. The Graph cuts can be used to optimize the boundary between two images being stitched while maintaining important portions of viewable landmarks in the side view images. The stitching module can also compensate for changing photographic exposure settings between the side view images.

A Laplacian blending module that is part of the compositing module 236 can blend the vertical seams. In Laplacian blending, a difference of Gaussians (DoG) pyramid can be built for the source and target images. A Laplacian pyramid represents a single image as a sum of detail at different resolution levels. In other words, a Laplacian pyramid is a bandpass image pyramid obtained by forming images representing the difference between successive levels of the Gaussian pyramid. In blending, each level can contain the frequencies not captured at coarser levels in the Gaussian pyramid. For blending to take place, the pyramid levels of the mask are used to combine (with alpha blending) the Laplacian levels of the source and target, creating a new Laplacian pyramid. When the image is regenerated from this pyramid, the lower frequencies can be blended and higher frequencies preserved.

The image generation module 220 may execute on computing device 298 that is a server, a workstation, or another computing node. The computing device or computing node can include a hardware processor device 290, a hardware memory device 292, a local communication bus 294 to enable communication between hardware devices and components, and a networking device 296 for communication across a network with other image generation modules, processes on other compute nodes, or other computing devices. A display module 250 can also be provided to display the strip panorama 252 on a display device or to send the strip panorama to a hardware display device.

A more detailed example of the present technology will now be discussed. An initial operation can be planning to generate a strip panorama. The planning operations can determine which road segments to group together into roads or block views and which image panoramas to stitch together for a given road. The side view images can then be extracted from the panorama bubbles by rendering wide angle side-facing views. Then a strip panorama or block view can be created by stitching together the selected side view images.

In the planning stage, thousands, millions or even more panoramas may be extracted from a cluster of image panoramas. The captured panoramas can include location and orientation metadata for the panoramas. For example, a location may be a geographic position using latitude and longitude obtained from a global positioning system (GPS) device when an image panorama is captured using a group of cameras. The orientation may include a measurement for magnetic north or another orientation reference. A map of a road network can also be received as input, where the map describes geographic areas with panorama coverage. Camera files can also be created that include metadata files to enable the subsequent stages of the strip panorama processing pipeline to work on the grouped panorama images, and one metadata file may be aggregated for each strip panorama.

The panoramas can be clustered by proximity. For example, a city or defined geographic area of N×M kilometers square may be considered a proximity.

Once a cluster of image panoramas has been obtained, a road network can be retrieved for a proximity area (e.g., a cluster bounding box) and then the road edges can be grouped together into roads. The grouping of the road edges may be performed by applying a greedy method. A simplified listing of operations (e.g., pseudo code) that may be used in the greedy method are listed:

Start with any untagged road edge

Tag the road edge with an identifier (ID)

Recursively try to extend the current road group in both directions using these rules:

If there is an edge with the same road name and the turn angle is <25 degrees, then add the edge to the road.

If there is an edge with a different name and the turn angle is <10 degrees, then add the edge to the road.

Otherwise stop extending the road.

Repeat

This can result in many linear road groups. Other road grouping methods can also be used.

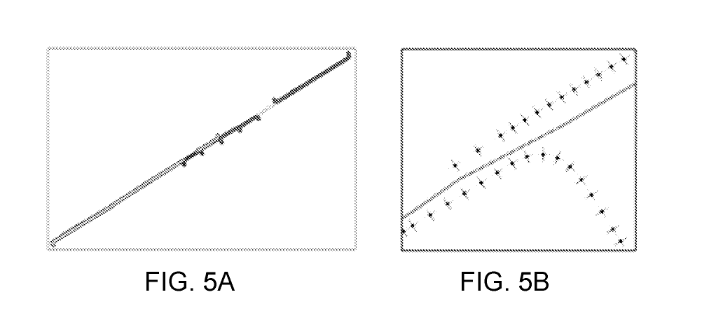

The next part of the method selects a series of panoramas for each road group. First, metadata can be extracted for the panoramas along a narrow corridor around the current road group. FIG. 5A illustrates an example street and FIG. 5B shows a zoomed-in image of FIG. 5A with each cross icon representing a panorama taken at a geographic location on a road.

A sequence of panoramas can then be selected starting from one end of a road group and traversing to the other end of the road group. The panorama selection can optimize a score function to prefer the selection of:

1. Panoramas that are closer to the road vector and oriented along the road vector

2. Subsequent panoramas from one vehicle's same photography run

3. Panoramas that minimize jumps across different vehicle photography runs

If there are gaps in the panorama coverage, multiple panorama sequences or groups can be produced that may become multiple block views or strip panoramas later. For each sequence of panoramas, two camera files can be produced to store the list of selected panoramas and parameters used for rendering the side facing views (i.e. the orientation of a virtual camera). The two files may store the left and right side of the road respectively.

Side view images may then be extracted from panoramas. The side views can be extracted from the camera image files that were used to capture the panorama at each geographical point. For each panorama sequence, a storage area can be created for files containing rendered side views. The storage area may be a mass storage device such as a hard disk drive, an optical storage drive or a flash memory. The cube image maps for each panorama in a panorama sequence can be loaded, and then the side views can be rendered. This stage can be processed in parallel, if desired.

Another operation is stitching the side view images together. The input to the stitching operation can include camera files with metadata and the extracted side view images. The eventual result of the stitching operation is a strip panorama and related metadata.

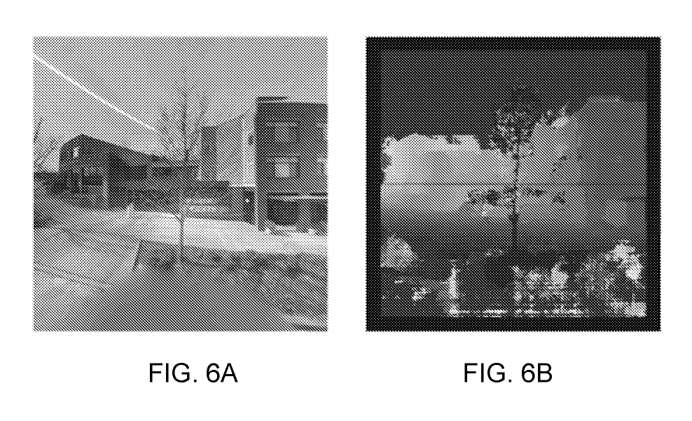

The following additional operations can be repeated for each strip panorama and may be executed in parallel as desired. Depth maps can be computed for the side view images using dense stereo matching. In one example method for creating a depth map, the pixel values of three consecutive images (e.g., adjacent images) can be operated on. The output for the depth maps includes pairs of depth maps and confidence maps for each group of three images. FIG. 6A illustrates just one center side view image from the three side view images that may be used to generate a depth map, and FIG. 6B illustrates a corresponding depth map.

A further operation can be used to align neighboring images. A good alignment for each image column can be obtained using image translation and scaling. A given image alignment can generally align scene objects at one specific depth. Objects further away may be duplicated in the image and objects closer may get cut out depending on the selected alignment depth. This is typically due to the movement of the camera between taking the panoramas or cube images and/or the effects of parallax. Thus, the depths of the building facades can be detected to align the images according to selected building depths.

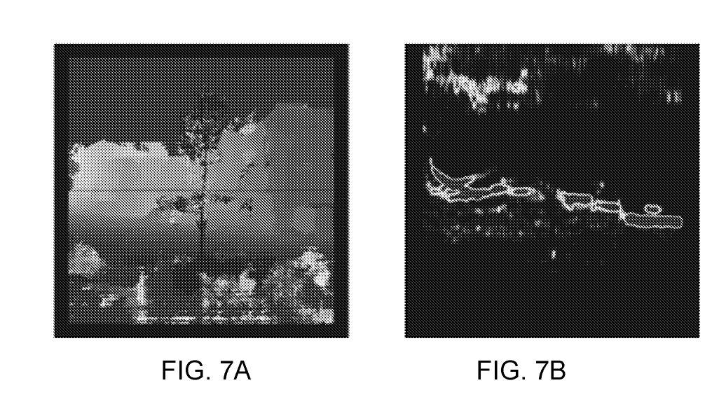

In order to determine where to align the images, a depth histogram is computed for the side view images. More formally speaking, given a depth map D where each pixel (x,y) stores the distance z to the scene, a new image depth histogram (DH) can be computed where the columns in the DH correspond to the image columns in the depth map and the pixels in the rows represent bins for the depth ranges of pixels in a column in the depth map. For every depth sample (x,y)=z in D, a Gaussian count can be added to the DH at location (x, log(z)). Thus, a bin that has many pixels at that depth may be brighter value bin or a hotter color than bins that do not have many pixels at another depth. FIG. 7A illustrates an example depth map and FIG. 7B illustrates an example depth histogram that can be created using the depth maps.

The idea behind the depth histograms is that for certain planar objects, man-made objects, or vertical building facades, many pixels are at the same depth. Thus, a strong peak may be seen in the depth histogram where there are many pixels in a column that have the same or similar depths in the depth image.

In one alignment example, the good alignment for an image column can be at the depth where a maximum peak value is found in the depth histogram. However, the histograms can be sensitive to noise and errors in the depth map computation.

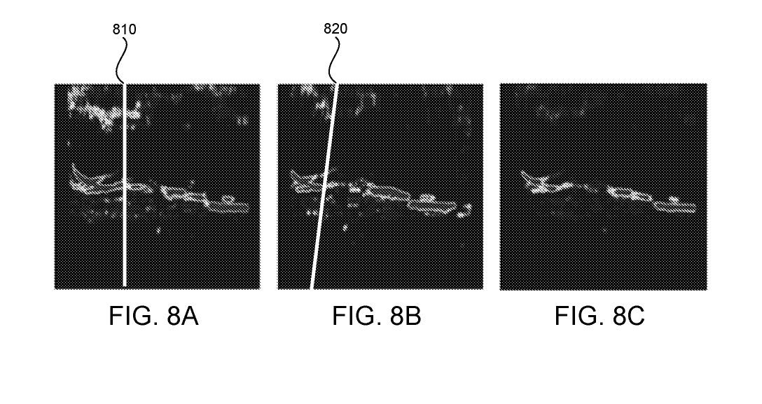

In another example of computing a depth histogram, the approach can combine information from both a left image I1 and right image I2. The depth histograms DH1 in FIG. 8A and DH2 in FIG. 8B can be computed from the left image I1 and right image I2. FIG. 8A illustrates a column 810 in DH1 that can correspond to a slanted line 820 in FIG. 8B or DH2, depending on the relative camera locations, orientations, and parallax effects. In other words, the slanted line represents an expect shift in a column as the camera moves between taking the two images. The information from the two depth maps can be combined by multiplying values along both lines and this is repeated for each column in the depth histograms. Thus, a peak “survives” the multiplication operation when the peak exists in both images. FIG. 8C illustrates an example of how this depth histogram approach can reduce noise in the upper left part of the image.

Another task is to stitch the side view images together. This means a good column to use jumping to the next image is desired to be found. In order to make this assessment, a scoring function can be used to weigh a number of factors and pick a desirable solution. The factors can include, but are not limited to:

Quality of alignment

Favoring stitching on front-parallel house facades

Favoring selecting center regions from the side view images

Favoring selecting wide slabs from panoramas near intersections

The first two items above are related to the alignment cost which was computed before. The quality of the alignment is related to the magnitude of the peak in the depth histogram.

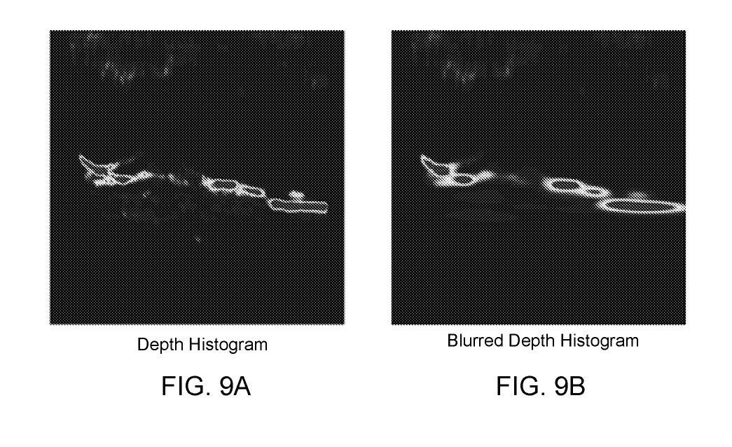

To make the method favor stitching on front-parallel house facades, these relatively flat structures can be identified as corresponding to horizontal structures of high magnitude in the depth histogram. These areas can be made more prominent by convolving the image with an elongated horizontal blur kernel. FIG. 9A illustrates a depth histogram and FIG. 9B illustrates a blurred depth histogram using the horizontal blur kernel.

Another factor in the stitching process is to try to select center pieces from each side image. By favoring the selection of center pieces, the final image is more likely to look as if a viewer is looking straight onto the scene. If the centers of the side view images are not favored, then parts of the panorama may appear as if the viewer is looking at buildings or other structures from the side.

During stitching, wide areas from intersections in the side view images are favored due in part to the lack of buildings at the intersection. As a result, as much of the whole image that is available or usable for a road intersection can be selected from a single side view image. This is desirable because then a final depiction of the strip panorama is more likely look similar to what a viewer may see when actually standing at a physical intersection. Specifically, the viewer can typically see the facades on both side of the crossing street and the vanishing lines of the buildings converge. The more of a single image that can be selected at a road intersection, the more natural the intersection is likely to look.

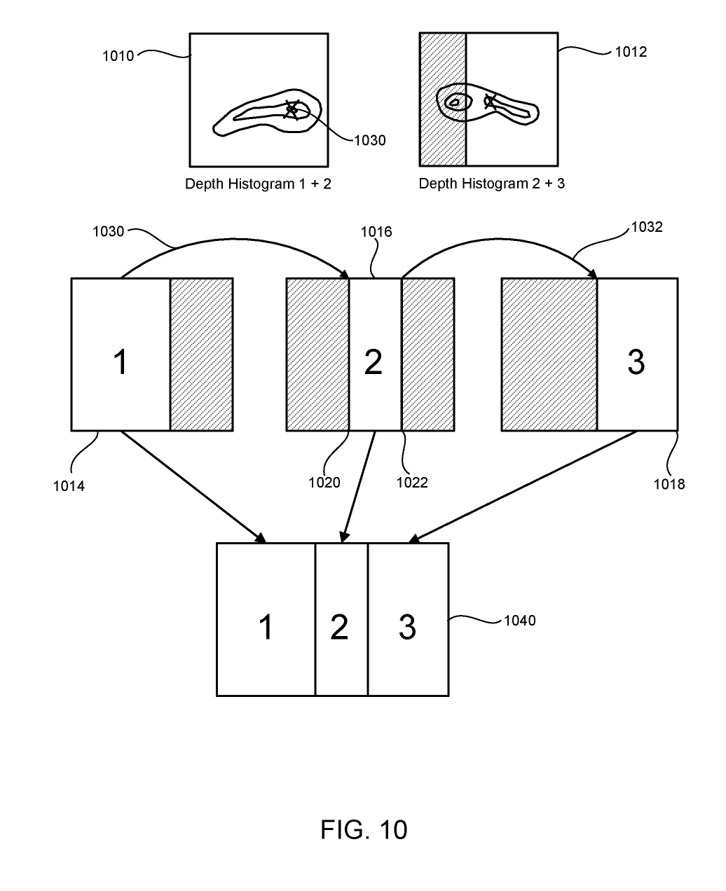

FIG. 10 illustrates a summary of a stitching process with two depth histograms (DH). One depth histogram 1010 is provided for the image 1 and image 2 transition and the other depth histogram 1012 is provided for the image 2 and image 3 transition.

In each of these depth histograms, the horizontal axis represents horizontal position in the original depth image (i.e., a vertical scanline), and the vertical axis represents scene depth value. The value and/or color at a pixel or grid location in the depth histograms can represent how much of a displayed depth is seen along that vertical scanline or column. A “hot spot” 1030 means there are many depth entries in the bin at that depth and column location in the depth image. For example, if the vertical scanline is through a wall, then the depth of that wall dominates the vertical scanline. Using a peak location as a transition point can be effective, especially if the next image also sees the same depth frequently at a corresponding point in the depth histogram. This column location can create a seam with fewer artifacts since the depths agree. For each point in the depth histogram, the corresponding horizontal position in the next histogram depends in part on depth, due to parallax. At infinite distances, there is no parallax, thus the horizontal position is unchanged. At nearby distances, parallax causes the corresponding horizontal position to shift in the next histogram.

Each pixel column in the depth histogram images corresponds to a possible transition from left to right image, as shown by arrows 1030, 1032 in the middle row images 1014, 1016, 1018. The transition can be characterized by the columns where the left image is exited and the right image is entered (i.e. begins). Each possible transition also has a score through the multiplication and the blurring. As discussed, maximizing the sum of the scores of the transitions is desirable.

Once a transition 1020 from image 1 to image 2 is selected, the column where image 2 is exited 1022 has to lie to the right of the column where image 2 is entered 1020. Because of these constraints, the column that produces a maximum score cannot always be automatically selected. Instead dynamic programming techniques can be used to find a good solution. Dynamic programming techniques break the overall solution into several sub-parts to solve first before the overall solution is reached. In this case, at least four features can be solved for first, namely the quality of alignment, favoring stitching on front-parallel house facades, favoring selecting center regions from the images, and favoring selecting wide slabs from panoramas near intersections. Once such features have been solved for then the overall stitching problem can be solved. A desired stitch between the multiple side views may be selected using the dynamic programming method to maximize an overall score. For example, the sum of the scores can be maximized while meeting the constraints of always moving forward (to the right) with the stitching seams. Alternatively, a desirable score can also be selected that is not particularly optimal. The stitching can result in a stitched strip panorama 1040.

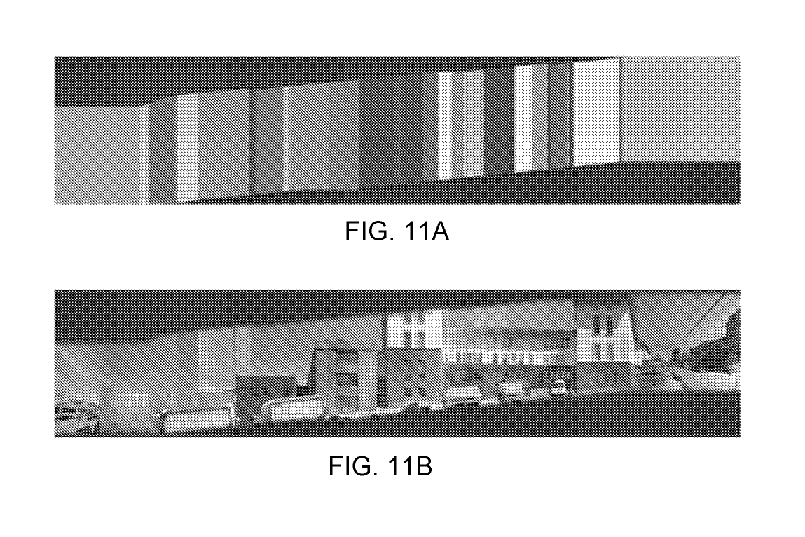

Smooth “trimming lines” can also be computed for the top and bottom of the panorama. After the image slabs or image blocks are stitched and composited together, the bounding box of the pixels in the side view images can be examined, and the pixels can be classified as being inside or outside the stitched imagery. Then two lines can be picked for the top and bottom boundaries that try to satisfy the following constraints: 1) Staying close to the upper/lower boundary of the stitched imagery; 2) Smoothly varying; and 3) Having approximately the same vertical distance across the panorama. These lines can be solved for by setting up a linear system which covers these soft constraints. Part of the area between the trimming lines and the image might lie outside the “known” imagery, and these pixels can be just filled smoothly in with a background color. Specifically, FIG. 11A illustrates various levels of gray scale representing the amount of a side view that is stitched into the strip panorama. FIG. 11B illustrates the stitched strip panorama as represented by FIG. 11A.

Because each of the images often have various exposure levels created by the auto exposure functions of cameras capturing the panoramas, the changing exposures values can have compensation applied for the various exposures. Since each panorama may use different exposure settings, the brightness and colors might change between the panoramas in the strip panorama. Overlapping regions of consecutive views can be used to compare the exposure differences between the side view images, and a linear system can be solved to compensate for changing gains.

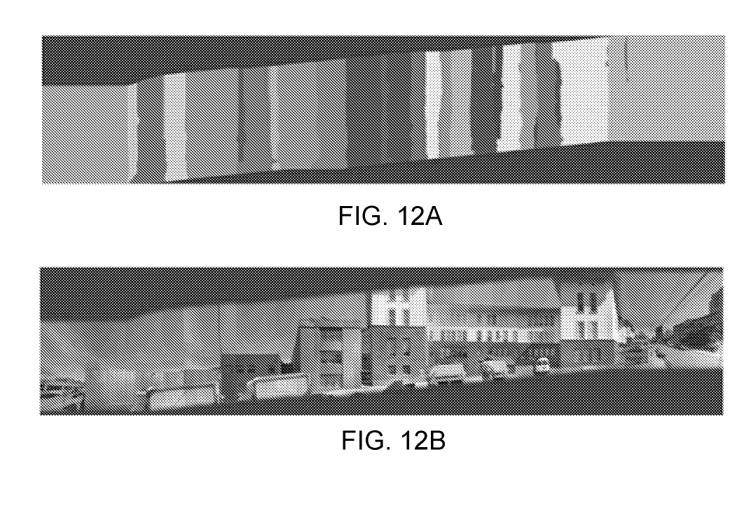

The vertical seams between views can be refined using Graph cuts. FIG. 12A illustrates the Graph cuts as identified by different levels of gray scale for the strip panorama. The output of the Graph cuts as in FIG. 12B illustrates that the cars and the right tower type of building are left intact.

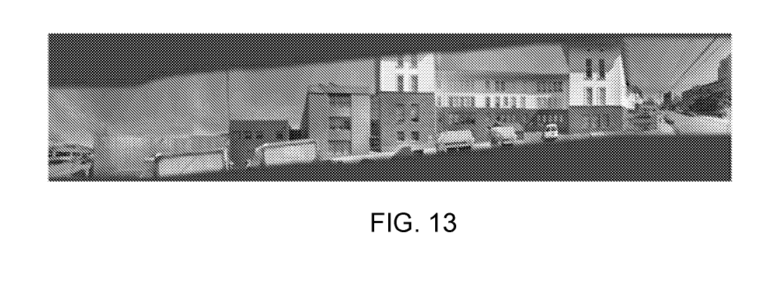

The abruptness of the seams may be reduced using Laplacian blending, as described before. FIG. 13 illustrates the strip panorama with Laplacian blending. A final blended result can be saved as a tile pyramid that allows a user to deeply zoom into the strip panorama.

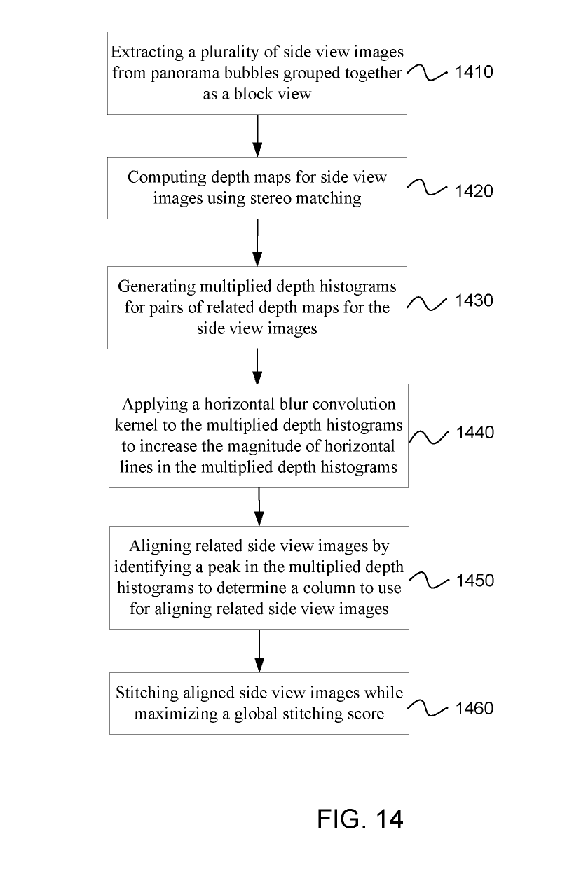

FIG. 14 illustrates another example of a method for generating multi-perspective strip panoramas. The operations illustrated in blocks 1410-1430 have been described previously. This method can include applying a horizontal blur convolution kernel to the column-depth alignment scores of the depth histograms to increase the magnitude of horizontal structures in the depth histograms and to enable a stitching operation identify a depth of manmade structures, as in block 1440.

The related side view images can be aligned using the depth histograms by identifying a peak in column-depth alignment scores of the depth histograms to determine a column to use for aligning related side view images, as in block 1450. The aligned side view images can then be stitched together while maximizing a global stitching score, as in block 860.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

Furthermore, the described features, structures, or characteristics may be combined in any suitable manner in one or more embodiments. In the preceding description, numerous specific details were provided, such as examples of various configurations to provide a thorough understanding of embodiments of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. The “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A method for generating a strip panorama, comprising:
selecting a plurality of panoramas grouped together for a road to combine into the strip panorama;
extracting side view images from the plurality of panoramas;
computing depth maps for side view images using stereo matching;
generating depth histograms using depth map columns from the depth maps, the depth histograms having column-depth alignment scores computed by multiplying corresponding depth values from at least two related depth histogram maps;
aligning related side view images using the column-depth alignment scores; and
stitching aligned side view images while maximizing a stitching score.

2. The method as in claim 1, further comprising identifying a peak in the column-depth alignment scores to determine a column to use for aligning a first a side view image adjacent to a second side view image.

3. The method as in claim 1, wherein the depth histograms have columns corresponding to columns in the side view images and rows that are bins for different depth ranges.

4. The method as in claim 1, further comprising applying a horizontal blur convolution kernel to the column-depth alignment scores to increase a relative magnitude of horizontal structures in the column-depth alignment scores and enable a stitching operation to better identify a depth of man-made structures in the side view images.

5. The method as in claim 1, wherein a depth of a building facade is used as a defined depth for aligning and stitching side view images.

6. The method as in claim 1, further comprising grouping a plurality of panoramas together as a strip panorama based on panoramas associated with grouped road segments.

7. The method as in claim 6, wherein the plurality of panoramas are grouped together by optimizing a score function based on panoramas that are: close to the road vector, oriented along the road vector, subsequent panoramas from the same vehicle photographic run, or panoramas that minimize jumps between panoramas taken by different vehicles.

8. The method as in claim 1, further comprising:
refining vertical seams created by stitching using Graph cuts to form refined seams; and
applying Laplacian blending to blend the refined seams.

9. The method as in claim 1, further comprising compensating for changing photographic exposure settings between the side view images using gain compensation.

10. The method as in claim 1, further comprising computing trimming lines for the top and bottom edges of the panorama.

11. A method as in claim 1, further comprising maximizing a global stitching score by optimizing for stitching features selected from the group consisting of: alignment quality, favoring for stitching on front-parallel building facades, favoring selecting center regions from the images and favoring wide slabs from images near intersections.

12. A system for generating a multi-perspective strip panorama, comprising:
an extraction module to extract side view images from panoramas grouped together for a road;
a depth map module to compute depth maps for side view images using stereo matching and to generate column-depth alignment scores for pairs of depth maps for the side view images;
an alignment module to align related side view images using the column-depth alignment scores; and
a stitching module to stitch aligned side view images while maximizing a stitching score.

13. A system as in claim 12, wherein the alignment module identifies a peak in the column-depth alignment scores to determine an image column to use for aligning a side view image near another side view image.

14. The method as in claim 12, further comprising a filter module to apply a horizontal blur convolution kernel to the column-depth alignment scores to increase a relative magnitude of horizontal structures in the depth histogram and enable a stitching operation to more accurately identify a depth of manmade structures.

15. A system as in claim 12, further comprising a compositing module to refine stitching seams and blend the stitched final images to compute the multi-perspective strip panorama.

16. The method as in claim 12, further comprising a compositing module to compensate for changing photographic exposure settings between the side view images.

17. The method as in claim 12, wherein the depth histograms are generated with: columns in the depth histograms corresponding to columns in the depth maps, rows that are depth bins, values representing a number of pixels categorized into a depth bin.

18. A method for generating a multi-perspective strip panorama, comprising:
extracting a plurality of side view images from panoramas grouped together as the multi-perspective strip panorama;
computing depth maps for side view images using stereo matching;
generating column-depth alignment scores for pairs of related depth maps for the side view images;
applying a horizontal blur convolution kernel to the column-depth alignment scores to increase a relative magnitude of horizontal structures in the column-depth alignment scores and to enable a stitching operation to identify a depth of manmade structures. aligning related side view images using the column-depth alignment scores by identifying a peak in the column-depth alignment scores to determine a column to use for aligning related side view images; and
stitching aligned side view images while maximizing a stitching score.

19. The method as in claim 18, further comprising:
refining vertical seams created by stitching using Graph cuts to form refined seams; and
applying Laplacian blending to blend the refined seams.

20. The method as in claim 18, further comprising compensating for changing photographic exposure settings between the side view images.
